(19) United States
(12) Patent Application Publication
(10) Pub. No.: US 2014/0171123 A1
(43) Pub. Date: Jun. 19, 2014

(54) RECONFIGURATION OF MOBILE ELECTRONIC DEVICES BASED ON LOCATION

(71) Applicant: VISTEON GLOBAL TECHNOLOGIES, INC., Van Buren Township, MI (US)

(72) Inventors: Dinu Petre Madau, Canton, MI (US); John Robert Balint, III, Saline, MI (US)

(73) Assignee: Visteon Global Technologies, Inc., Van Buren Township, MI (US)

(21) Appl. No.: 13/714,001

(22) Filed: Dec. 13, 2012

(51) Int. Cl. H04W 4/04

(52) U.S. Cl. CPC H04W 4/046
USPC 455/456.4

(57) ABSTRACT

Systems and methods of configuring mobile electronic devices are provided. In one aspect, a system includes a vehicle, a mobile electronic device including a first manner of operation and a second manner of operation different than the first manner of operation, and a wireless charging system positioned in the vehicle and adapted to wirelessly charge the mobile electronic device. The mobile electronic device operates in the first manner of operation outside of the vehicle, and the wireless charging system identifies the mobile electronic device when the mobile electronic device is inside the vehicle and operation of the mobile electronic device changes from the first manner of operation to the second manner of operation with the mobile electronic device in the vehicle. In another aspect, the system includes a wireless charging system positioned at any location and adapted to communicate data to a mobile electronic device associated with the location.

### FIELD OF THE DISCLOSURE

This disclosure generally relates to reconfiguration of a mobile electronic device based on the location of the device and, more particularly, to reconfiguration of a mobile electronic device from a first manner of operation when the device is distal of a location to a second manner of operation when the device is proximate the location.

### BACKGROUND

Mobile electronic devices, such as phones, smartphones, tablets, etc., have a wide variety of features enabling a wide variety of operations. Certain features and operations of mobile electronic devices are desired or appropriate in one location or venue, but are not desired or appropriate in another location. Many locations exist where certain features and operations of the mobile electronic device are desired or appropriate.

One such example includes a bedroom. A user may desire the mobile electronic device to be in a silent mode or a power off mode because the user does not want to be disturbed when sleeping.

Another exemplary location where some features and operations are desirable and other features and operations are not desirable includes a vehicle. Some of the mobile electronic device operations require significant attention from a user and/or require a user to manipulate of the devices with his/her hands. While a user's attention and use of hands are acceptable in most situations, such attention and hand use are not desirable when the user is in a vehicle such as, for example, an automobile. Many states and countries have laws prohibiting users from performing certain operations on their mobile electronic devices while inside a vehicle. Even in states and countries without such laws, performing certain operations of a mobile electronic device can be dangerous. Thus, in order for a user to abide by certain laws and/or for safety purposes, the user may manually change the operation of his/her mobile electronic device when the user gets into a vehicle. The user manually manipulates the various buttons and menus in the mobile electronic device to reconfigure operation of the mobile electronic device to a desirable or appropriate manner of operation for the circumstances. This manual manipulation is time consuming and may not result in a desired or proper reconfiguration of the device if the user makes an error.

Apparatuses, systems, and methods are needed to overcome one or more issues of one or more of the prior systems and methods.

### SUMMARY

In one aspect, a system is provided and includes a vehicle, a mobile electronic device including a first manner of operation and a second manner of operation different than the first manner of operation, and a wireless charging system positioned in the vehicle and adapted to wirelessly charge the mobile electronic device. The mobile electronic device operates in the first manner of operation outside of the vehicle, and the wireless charging system identifies the mobile electronic device when the mobile electronic device is inside the vehicle and operation of the mobile electronic device changes from the first manner of operation to the second manner of operation with the mobile electronic device inside the vehicle.

In another aspect, a system is provided and includes a mobile electronic device including a first manner of operation and a second manner of operation different than the first manner of operation, and a wireless charging system positioned at a location. The wireless charging system is adapted to wirelessly charge the mobile electronic device and communicate with the mobile electronic device with the mobile electronic device in proximity of the location. The mobile electronic device operates in the first manner of operation distal from the location. The wireless charging system identifies and communicates with the mobile electronic device with the mobile electronic device in proximity to the location. The mobile electronic device changes from the first manner of operation to the second manner of operation as a result of the communication from the wireless charging system.

In a further aspect, a method of operating a mobile electronic device is provided and includes operating a mobile electronic device in a first manner of operation externally of a vehicle, introducing the mobile electronic device into the vehicle, positioning the mobile electronic device in proximity to a wireless charging system positioned in the vehicle, establishing communication between the mobile electronic device and the wireless charging system, and altering operation of the mobile electronic device to a second manner of operation different than the first manner of operation as a result of communication between the mobile electronic device and the wireless charging system.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is an exemplary environment or system including an exemplary vehicle, in which principles of the disclosure may be implemented, the vehicle illustrates an exemplary wireless charging system positioned in the vehicle, in accordance with one embodiment;

FIG. 2 is an enlarged perspective view of the exemplary wireless charging system and an exemplary mobile electronic device of the system illustrated in FIG. 1, in accordance with one embodiment;

FIG. 3 is a schematic diagram of an exemplary vehicle of the system illustrated in FIG. 1, in accordance with one embodiment;

FIG. 4 is a schematic diagram of an exemplary mobile electronic device of the system illustrated in FIG. 1, in accordance with one embodiment;

FIG. 5 is a flowchart of at least a portion of the exemplary operation of the system illustrated in FIG. 1, in accordance with one embodiment;

FIG. 6 is a flowchart of at least another portion of the exemplary operation of the system illustrated in FIG. 1, in accordance with one embodiment; and

FIG. 7 is a flowchart of at least a further portion of the exemplary operation of the system illustrated in FIG. 1, in accordance with one embodiment.

### DETAILED DESCRIPTION

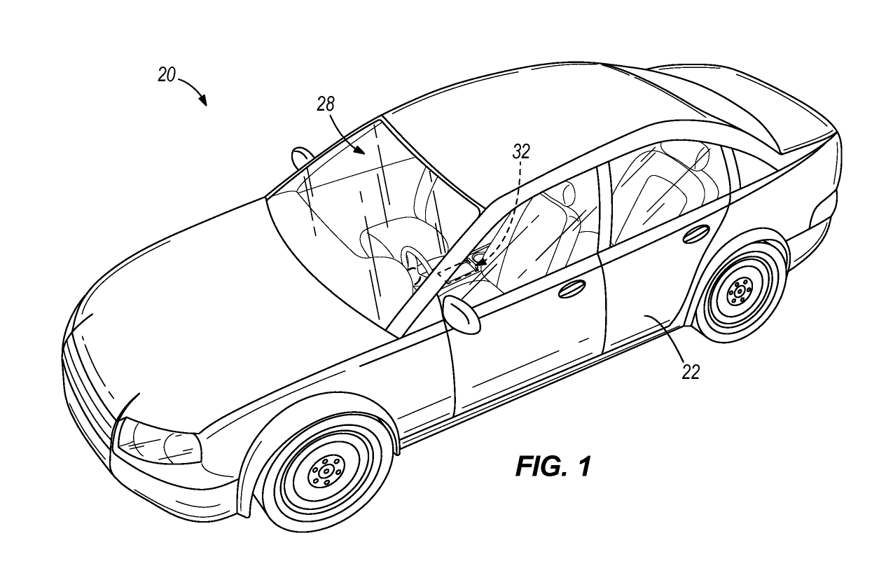

With reference to FIG. 1, an exemplary environment or system 20 is illustrated in which principles of the disclosure may be implemented. The system 20 is adapted to automatically reconfigure operation of a mobile electronic device 24 based on the location of the mobile electronic device 24. In the illustrated exemplary embodiment, the system 20 includes a vehicle 22 as the location. The illustrated vehicle 22 is only an exemplary vehicle and is not intended to be limiting. Rather, any type of vehicle may include the principles of the disclosure. Additionally, the system 20 is adapted to automatically reconfigure operation of the mobile electronic device 24 at any location. Other exemplary locations include, but are not limited to, a house or other residence, a bedroom, a kitchen, an office, a coffee shop, a concert, a retail location, a location where commerce occurs, or any other location. The principles of the disclosure can apply to any location and all of such locations are intended to be within the spirit and scope of the present disclosure.

The following description and associated figures identify a vehicle as the location in which operation of a mobile electronic device will be automatically reconfigured. The recitation of a vehicle is not intended to be limiting upon the present disclosure and, instead, is presented to demonstrate the principles of the invention.

In the illustrated exemplary embodiment, the system 20 is adapted to automatically reconfigure operation of the mobile electronic device 24 from a first manner of operation when the device 24 is located externally of the vehicle 22 to a second manner of operation when the device 24 is located internally of the vehicle 22. The system 20 is also adapted to automatically reconfigure any type of mobile electronic device 24. Exemplary mobile electronic devices include, but are not limited to: cellular phones; wireless phones; smartphones such as iPhones®, Blackberry® smartphones, Android® enabled smartphones; tablets; other mobile electronic communication devices; laptop computers; portable audio players; etc. Description and illustrations herein of any particular type of mobile electronic device is merely to demonstrate the principles of the disclosure and is not intended to be limiting.

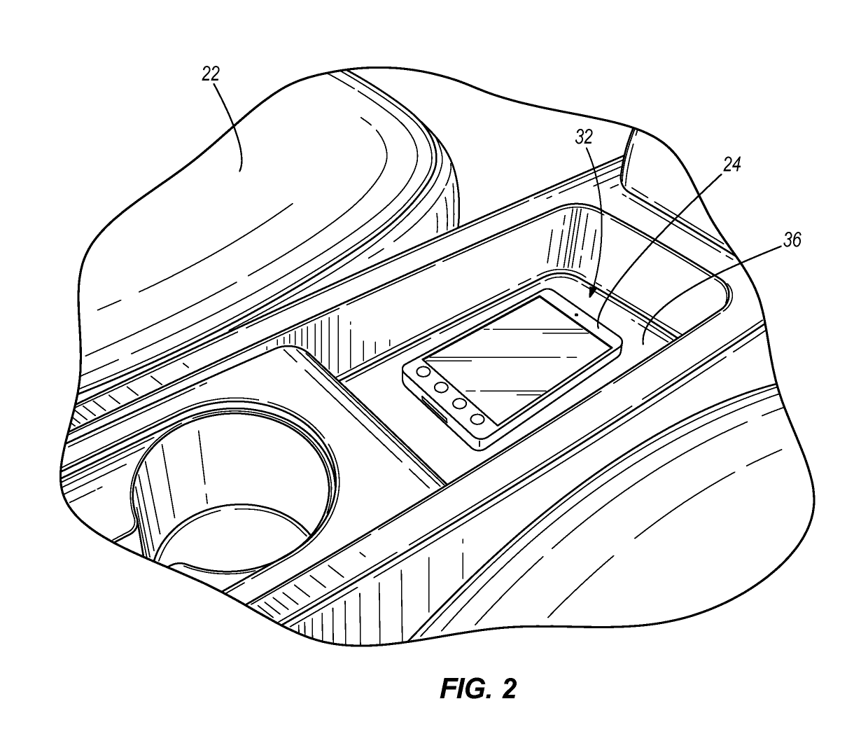

With continued reference to FIG. 1 and additional reference to FIG. 2, the exemplary vehicle 22 includes a cabin 28 that may be occupied by passengers during operation of the vehicle 22 and a charging system 32 located internally of the cabin 28 for charging mobile electronic devices 24. The charging system 32 may be any type of charging system adapted to charge mobile electronic devices 24. In the illustrated exemplary embodiment, the charging system 32 is a wireless charging system. However, the charging system 32 may also be a wired charging system. The wireless charging system 32 includes all of the necessary mechanical and electrical components commonly found in wireless charging systems in order to appropriately charge mobile electronic devices 24. In order for the wireless charging system 32 to appropriately charge the mobile electronic device 24, the device 24 must be positioned in proximity to the wireless charging system 32.

In the illustrated exemplary embodiment, the wireless charging system 32 includes a surface 36 upon which a mobile electronic device 24 may be placed or supported. Once the device 24 is brought sufficiently close in proximity to the wireless charging system 32 or when the device 24 is placed on the surface 36 of the wireless charging system 32, the wireless charging system 32 begins to charge the mobile electronic device 24.

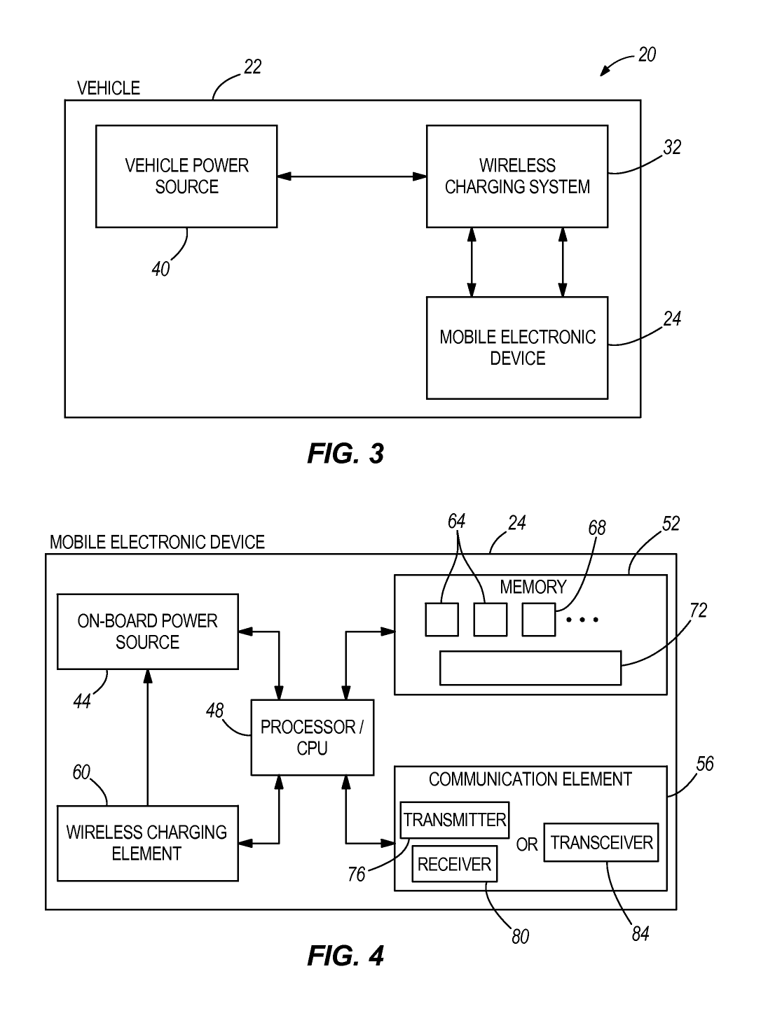

FIG. 3 schematically illustrates the exemplary vehicle 22 shown in FIG. 1. The vehicle 22 includes a power source 40 (e.g., a vehicle battery), the wireless charging system 32, and the mobile electronic device 24 when the device 24 is positioned in the vehicle 22. Transfer of power between the vehicle power source 40 and the wireless charging system 32 may be a wired connection. In the illustrated exemplary embodiment, transfer of power and communication between the wireless charging system 32 and the mobile electronic device 24 may be wireless. Alternatively, as indicated above, the charging system 32 may also be a wired charging system. Thus, in such alternatives, transfer of power and communication between the charging system and the mobile electronic device 24 may be along wires or cables.

FIG. 4 schematically illustrates an exemplary mobile electronic device 24 of the system 20. The mobile electronic device 24 includes an on-board power source 44, a processor or central processing unit (CPU) 48, memory 52, a communication element 56, and a wireless charging element 60. The on-board power source 44 may be a battery of any type, but preferably batteries commonly used on mobile electronic devices 24. The on-board power source 44 is adapted to provide power to the mobile electronic device 24 and its components to facilitate operation of the device 24. The processor/CPU 48 may be any type of processor or CPU as long as it is capable of performing the necessary operations to achieve the principles of the disclosure. The processor/CPU 48 communicates with the on-board power source 44, the memory 52, the communication element 56, and the wireless charging element 60 to achieve all the operations of the mobile electronic device 24. The memory 52 can be any type of memory such as, for example, RAM, ROM, etc., adapted to store any type of data. In the illustrated exemplary embodiment, the memory 52 is adapted to store user defined data profiles 64, predetermined data profiles 68, and other types of data 72 (described in more detail below). The communication element 56 includes all the necessary components to achieve any type of communication with one or more other devices. Communication may include, for example, cellular communication, local area network (LAN) communication, wide area network (WAN) communication, Bluetooth® communication, Wi-Fi communication, etc. For example, the communication element 56 may include a transmitter 76 and a receiver 80, a transceiver 84, or any other type of sending and receiving devices to perform at least some of the exemplary types of communication. The wireless charging element 60 includes all the components required on the mobile electronic device 24 to achieve wireless charging of the device 24. The components of the wireless charging element 60 cooperate with wireless charging components in the vehicle wireless charging system 32 to wirelessly charge the on-board power source 44 of the mobile electronic device 24. As indicated above, the charging system 32 of the system 20 may be a wired charging system and, accordingly, the mobile electronic device 24 would include a charging element including all the components required on the mobile electronic device 24 to achieve wired charging of the device 24.

The system 20 is adapted to automatically reconfigure operation of the mobile electronic device 24 when the device 24 is brought into proximity with or is placed on the surface 36 of the wireless charging system 32. Mobile electronic devices 24 may be operated in a wide variety of manners as a result of the many features and capabilities of the devices 24. The mobile electronic device 24 may be operated in one manner when a user is walking around, working, or otherwise not occupying or operating a vehicle 22, and may be operated in a different manner when the user is occupying or operating a vehicle 22. For example, a user may place cellular calls directly with the mobile electronic device 24 while holding onto the device 24 with his/her hands when the user is outside of a vehicle 22, and alternatively the user may place cellular calls with the mobile electronic device 24 in a hands-free mode via Bluetooth® communication between the device 24 and a vehicle phone system. This exemplary change in device operation is only one of many possible operation changes that may occur, is presented to demonstrate the principles of the disclosure, and is not intended to be limiting. Rather, operation of the mobile electronic device 24 may be altered in many different manners and all of such possibilities are intended to be part of this disclosure.

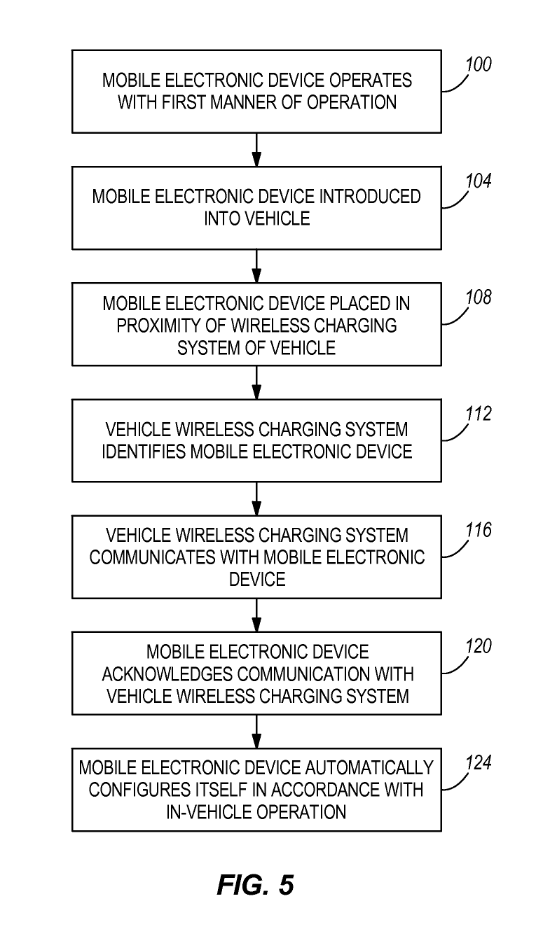

Referring now to FIG. 5, at least a portion of the operation of the mobile electronic device 24 will be described. The mobile electronic device 24 operates in a first manner of operation when the device 24 is external of a vehicle 22 (step 100). The mobile electronic device 24 is then introduced into a vehicle 22 (step 104) and may be placed in proximity or on the surface 36 of the wireless charging system 32 (step 108). The wireless charging system 32 in the vehicle 22 identifies that the mobile electronic device 24 is close to or on the surface 36 of the wireless charging system 32 (step 112). The wireless charging system 32 communicates with the mobile electronic device 24 (step 116) and the device 24 acknowledges communication with the wireless charging system 32 (step 120). Once the mobile electronic device 24 acknowledges communication with the wireless charging system 32, the device 24 automatically reconfigures itself to operate in a second manner of operation associated with in-vehicle operation (step 124). The second manner of operation is different than the first manner of operation. The differences in operation between the first manner and the second manner may be any type of operation changes.

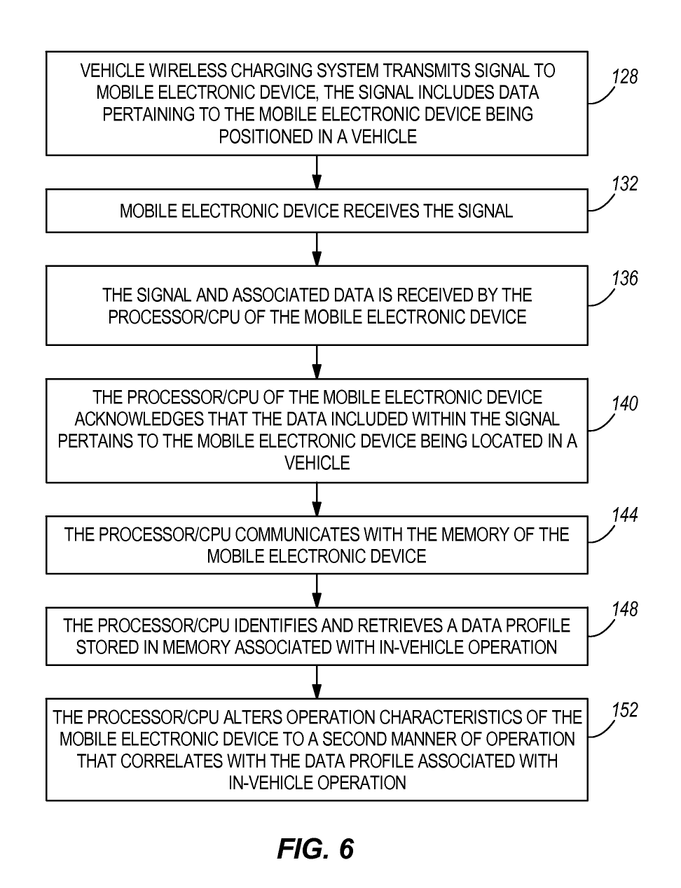

Referring now to FIG. 6, more details associated with steps 116-124 illustrated in FIG. 5 will be described. With respect to step 116 and communication between the wireless charging system 32 and the mobile electronic device 24, the wireless charging system 32 transmits a signal to the mobile electronic device 24 with the signal including data pertaining to the device 24 being positioned in the vehicle 22 (step 128), and the mobile electronic device 24 receives the signal from the wireless charging system 32 (step 132). With respect to step 120 and the device 24 acknowledging communication with the wireless charging system 32, the signal and associated data are received by the processor/CPU 48 of the mobile electronic device 24 (step 136) and the processor/CPU 48 acknowledges that the data included within the signal pertains to the device 24 being located within the vehicle 22 (step 140). With respect to step 124 and the device 24 automatically reconfiguring itself to operate in a second manner associated with in-vehicle operation, the processor/CPU 48 communicates with the memory 52 of the mobile electronic device 24 (step 144), and the processor/CPU 48 identifies and retrieves a data profile 64, 68 stored in the memory 52 associated with operating the device 24 in the second manner pertaining to in-vehicle operation (step 148). The data profile associated with in-vehicle operation may be a user created data profile 64 or the data profile may be a predetermined data profile 68 (e.g., a factory set data profile, a data profile created by a 3^{rd} party, or a data profile purchased by the user and downloaded to the memory 52). The processor/CPU 48 then alters operation characteristics of the mobile electronic device 24 to a second manner of operation that correlates with the data profile 64, 68 retrieved from memory 52 (step 152).

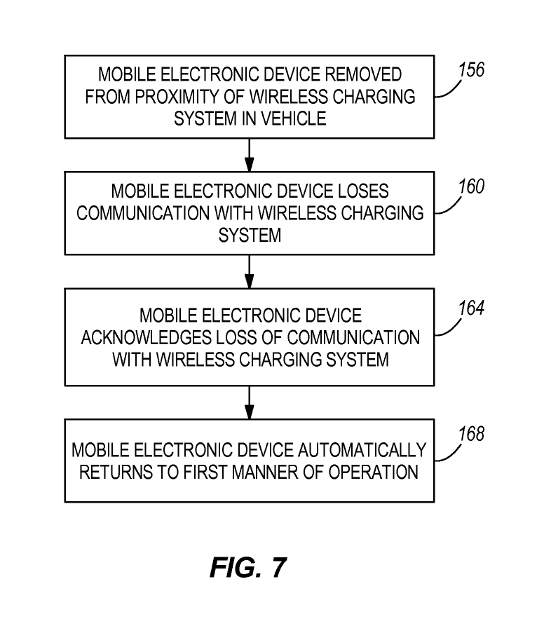

FIG. 7 illustrates a flowchart including at least a portion of the operation of the system 20 when the mobile electronic device 24 is removed from a vehicle 22. As indicated above, the device 24 is reconfigured to operate in a second manner when positioned proximate or on the wireless charging system 32. The mobile electronic device 24 may be removed from the wireless charging system 32 (step 156), which causes the device 24 to lose communication with the wireless charging system 32 (step 160). The mobile electronic device 24 acknowledges loss of communication with the wireless charging system 32 (step 164) and the device 24 automatically reconfigures or returns to the first manner of operation (step 168). Alternatively, the mobile electronic device 24 may reconfigure or change to a third manner of operation different than the first and second manners of operation. The third manner of operation may be associated with one of the data profiles 64, 68 stored in memory 52. The device 24 can automatically reconfigure to operate in any number of manners and a complementary number of data profiles 64, 68 may be stored in the memory 52 of the device 24.

The mobile electronic device 24 and the wireless charging system 32 may be enabled to communicate and reconfigure with each other without alterations or additional elements to either the device 24 or the wireless charging system 32. That is, all of the principles of the disclosure can be achieved by the device 24 and the wireless charging system 32 as they were manufactured. Alternatively, one or both of the mobile electronic device 24 and the wireless charging system 32 may require an application (e.g., software), a tie-in, or some other additional element that allows communication and reconfiguration between the device 24 and the wireless charging system 32. For example, an application may be downloaded to the mobile electronic device 24 to enable the device 24 to receive communications from the wireless charging system 32.

One or more embodiments of the disclosure may reduce one or more issues experienced by one or more current systems or methods by providing automatic reconfiguration of mobile electronic devices based on location of the mobile electronic devices. One or more embodiments of the disclosure may also have additional benefits over one or more other existing systems and methods.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the disclosure is defined by the appended claims. Accordingly, the disclosure is not to be restricted except in light of the appended claims and their equivalents.

1. A system comprising:
a vehicle;
a mobile electronic device including a first manner of operation and a second manner of operation different than the first manner of operation; and
a wireless charging system positioned in the vehicle and adapted to wirelessly charge the mobile electronic device;
wherein the mobile electronic device operates in the first manner of operation outside of the vehicle, and wherein the wireless charging system identifies the mobile electronic device when the mobile electronic device is inside the vehicle and operation of the mobile electronic device changes from the first manner of operation to the second manner of operation with the mobile electronic device inside the vehicle.

2. The system of claim 1, wherein the wireless charging system identifies the mobile electronic device when the mobile electronic device is in close proximity to the wireless charging system.

3. The system of claim 1, wherein the wireless charging system identifies the mobile electronic device when the mobile electronic device is positioned on a surface of the wireless charging system.

4. The system of claim 1, wherein the wireless charging system communicates with the mobile electronic device and the mobile electronic device changes operation to the second manner of operation as a result of the communication from the wireless charging system.

5. The system of claim 1, wherein the wireless charging system transmits a signal to the mobile electronic device, and wherein the signal includes data pertaining to the mobile electronic device being positioned in the vehicle.

6. The system of claim 5, wherein the mobile electronic device includes a memory and a data profile stored in the memory associated with the second manner of operation, and wherein the mobile electronic device receives the signal, retrieves the data profile from the memory, and operates in the second manner of operation associated with the data profile.

7. The system of claim 1, wherein the mobile electronic device returns operation to the first manner of operation when the mobile electronic device is removed from inside the vehicle.

8. The system of claim 1, wherein the mobile electronic device changes operation to a third manner of operation, different than the first manner of operation and the second manner of operation, when the mobile electronic device is removed from inside the vehicle.

9. The system of claim 1, wherein the mobile electronic device is one of a mobile electronic communication device, a cellular telephone, a smartphone, a tablet, a laptop computer, a wireless telephone, and a portable audio player.

10. A system comprising:
a mobile electronic device including a first manner of operation and a second manner of operation different than the first manner of operation; and
a wireless charging system positioned at a location, wherein the wireless charging system is adapted to wirelessly charge the mobile electronic device and communicate with the mobile electronic device with the mobile electronic device in proximity to the location;
wherein the mobile electronic device operates in the first manner of operation distal from the location, and wherein the wireless charging system identifies the mobile electronic device with the mobile electronic device in proximity to the location and operation of the mobile electronic device changes from the first manner of operation to the second manner of operation as a result of the communication from the wireless charging system.

11. The system of claim 10, wherein the wireless charging system transmits a signal to the mobile electronic device, and wherein the signal includes data pertaining to the location.

12. The system of claim 11, wherein the mobile electronic device includes a memory and a data profile stored in the memory associated with the second manner of operation, and wherein the mobile electronic device receives the signal, retrieves the data profile from the memory, and operates in the second manner of operation associated with the data profile.

13. The system of claim 10, wherein the location is one of a vehicle, a bedroom, a kitchen, a retail venue, a commercial venue, and a residence.

14. A method of operating a mobile electronic device, the method comprising:
operating a mobile electronic device in a first manner of operation externally of a vehicle;
introducing the mobile electronic device into the vehicle;
positioning the mobile electronic device in proximity to a wireless charging system positioned in the vehicle;
establishing communication between the mobile electronic device and the wireless charging system; and
altering operation of the mobile electronic device to a second manner of operation different than the first manner of operation as a result of communication between the mobile electronic device and the wireless charging system.

15. The method of claim 14, wherein positioning the mobile electronic device further comprises positioning the mobile electronic device on a surface of the wireless charging system.

16. The method of claim 14, wherein establishing communication further comprises transmitting a signal with the wireless charging system to the mobile electronic device, and wherein the signal includes data pertaining to the mobile electronic device being positioned in the vehicle.

17. The method of claim 16, wherein the mobile electronic device includes a memory and a data profile stored in the memory associated with the second manner of operation, and the method further comprising
receiving the signal with the mobile electronic device,
retrieving the data profile from the memory, and
operating the mobile electronic device in the second manner of operation associated with the data profile.

18. The method of claim 14, further comprising removing the mobile electronic device from the vehicle and returning operation of the mobile electronic device to the first manner of operation with the mobile electronic device removed from inside the vehicle.

19. The method of claim 14, further comprising removing the mobile electronic device from the vehicle and operating the mobile electronic device in a third manner of operation, different than the first manner of operation and the second manner of operation, with the mobile electronic device removed from the vehicle.

20. The method of claim 14, wherein the mobile electronic device is one of a mobile electronic communication device, a cellular telephone, a smartphone, a tablet, a laptop computer, a wireless telephone, and a portable audio player.
